(19) United States
(12) Patent Application Publication
(10) Pub. No.: US 2011/0111091 A1
(43) Pub. Date: May 12, 2011

(54) METHOD FOR PREPARING A LEAVEN FROM RAW MILK, LEAVEN OBTAINED BY MEANS OF THIS METHOD AND USE OF THIS LEAVEN FOR PRODUCING A MILK PRODUCT

(76) Inventors: Claude Dumarche, Chatelaillon Plage (FR); Sebastien Leclercq, Millau (FR)

(21) Appl. No.: 13/002,523

(22) PCT Filed: Jul. 3, 2009
(86) PCT No.: PCT/FR2009/051314

§ 371 Date: Jan. 4, 2011

(30) Foreign Application Priority Data
Jul. 4, 2008 (FR) 08.03808

(51) Int. Cl. A23C 9/12

(52) U.S. Cl. 426/42; 426/34; 426/61

(57) ABSTRACT

A method, termed “bionative” method, for preparing a leaven, in which: a raw milk is selected from the group formed from raw milks of which the pH is capable of reaching, during a step of stabilising fermentation by acidifying lactic fermentation of the raw milk, at least one selection temperature, a value of 5.5 in more than 15 h, and a minimum value of 5.0 in less than 48 h, and then a raw milk-stabilising treatment is carried out. The treatment includes at least one step, termed stabilising fermentation step, of acidifying lactic fermentation of a fermentation medium, including a first stabilising fermentation step carried out using a fermentation medium including the raw milk, in which at least one stabilising fermentation step is interrupted when the pH of the fermentation medium reaches a value of between 4.9 and 6.0.

The invention relates to a method for preparing a leaven from raw milk, to a leaven obtained by this method, and to the use of this leaven for producing a milk product.

Sanitary directives aimed at reducing the risks of food poisoning by eliminating pathogenic flora from milk products require professionals in the dairy industry to take drastic hygiene measures in the processes of producing and collecting milk, especially measures for disinfecting and decontaminating milking premises, the animals' udders, milking devices and milk storage devices. Furthermore, those directives have led to the generalisation of processes for the refrigerated storage of milk for from 48 hours to 72 hours on the farm, especially at a temperature in the region of +4° C. In this respect, the document. Michel V. et al. (2001), Lait, 81, pp. 575-592, describes the impact of varying sanitary conditions, adopted during the production of cows' milks, on the biological diversity of the microbial flora in such raw milks.

However, the decline in the average quantity of pathogenic flora in milk production, resulting from the implementation of these methods, is accompanied by a substantial reduction, in the raw milks, in the average quantity of useful flora for the fermentation of the milks and for the ripening of milk products obtained from raw milks, especially cheeses.

Moreover, in order to satisfy sanitary requirements aimed at limiting pathogenic flora in raw milks and at the same time to have a flora that is numerically important and suitable for effecting the lactic fermentation of the milk, the dairy industry advocates the use of ferments, called coculture ferments, whose composition is perfectly defined and readily reproducible. Such coculture ferments are composed of a pure microbiological strain or of a small number of pure microbiological strains, are prepared by isolation and cloning of those pure strains in research laboratories, and are therefore free of potentially pathogenic germs. Such coculture ferments are, for example, composed of a combination of one or more acidifying bacterial strain(s) and one or more non-acidifying bacterial strain(s) suitable for the typing of the products obtained from such ferments.

However, the development of the organoleptic properties and the sensory qualities of raw milk cheeses, and also their authenticity which is characteristic of a geographical or geomorphological zone, called a “terroir”, are a direct consequence of the use of raw milks having a naturally diversified flora, which is itself characteristic of that “terroir”. The original organoleptic qualities of raw milk cheeses in fact come from the expression of a large number of low molecular weight odorous and gustatory molecules which are produced during the enzymatic degradation of various constituents, especially protein constituents, of the milk. Accordingly, the richness and microbiological diversity of the raw milks permit the expression of enzymatic equipment, itself rich and diversified, which is at the origin of the production, in fermentation media, especially lactic fermentation media, and in ripening media, of molecules which are the origin of the characteristic tastes and odours of raw milk cheeses.

Various methods permitting the preparation of a bacterial cell concentrate from microbiologically pure strains are already known.

In a first type of known solution (see, for example, GB 1 205 733), a bacterial cell concentrate is prepared from a structurally characterised and commercially available strain of Streptococcus cremoris. Such a solution does not permit the preparation, from raw milk, of a leaven having a rich and diversified microbiological flora whose microbiological composition is representative of the geographical zone and the production practices of the raw milk.

A second type of known solution (WO 2006/067136), similar to the above, is a method for the rapid preparation of a concentrate of lactic bacteria, especially Lactococcus lactis, ssp cremoris, using a yeast extract as growth accelerator. Such a solution does not permit the preparation, from raw milk, of a highly diversified leaven either.

The invention aims to remedy those disadvantages by proposing a method for preparing, from raw milk, a leaven formed of a large number of different microbiological, especially bacterial, species.

The invention aims to propose a method for preparing a leaven whose composition contains a large number of different microbiological species and includes the major part of the useful cheese flora of the raw milk.

The invention also aims to propose such a method in which the raw milk is not treated with antiseptic, antibiotic or bacteriostatic compositions or with chemical elements capable of inhibiting or stimulating the growth of the flora of the raw milk.

The invention also aims to propose such a method in which there is no voluntary addition of microorganisms.

The invention also, and more particularly, aims to propose such a method which tends to comply with the health safety constraints to which milk producers and the dairy industry are subject.

In addition, the invention aims to propose such a method which preserves employees' work habits, which is simple to use, and the implementation of which involves only a small number of procedures.

The invention also aims to propose such a method which is carried out using inexpensive means and devices.

In addition, the invention aims to propose a leaven, especially but not exclusively a leaven obtained by such a method, which is composed of a large number of microbiological species including the major part of the useful cheese flora of the raw milk.

The invention further aims to propose such a leaven which includes the major part of the native flora of the raw milk diminished, however, by the pathogenic flora and the flora capable of spoiling the organoleptic qualities of the milk products subsequently obtained with such a leaven.

The invention aims to propose such a leaven which can be used in particular in the production, from milk treated by thermisation, by microfiltration or by pasteurisation, of milk products, especially cheeses, having organoleptic characteristics similar to those of milk products prepared directly from raw milks.

The invention further aims to propose such a biodiversified leaven which is composed of a large number of microbiological species and has increased resistance to fermentation accidents, especially to lytic accidents caused by bacteriophages.

The invention further aims to propose such a biodiversified leaven, composed of a large number of microbiological species, which is resistant to the subsequent development of pathogenic microorganisms in the leaven, especially by an effect of trophic competition, called the barrier effect, during a small-scale contamination.

The invention further aims to propose a leaven having a microbiological diversity which ensures the stability of the leaven, the preservation of its organoleptic properties and which permits the marketing thereof.

The invention further aims to propose a leaven produced from raw milk, which leaven meets current criteria in respect of sanitary quality.

The invention also aims to propose such a leaven whose microbiological composition is representative of the authenticity of a geographical zone having common characteristics, of the specificity of the agricultural and dairy practices of that geographical zone, and of its seasonal flora.

The invention also aims to propose such a leaven having a low production cost.

Another object of the invention is to propose the use of such a leaven in order to impart to foodstuffs produced from that leaven organoleptic properties, especially flavours, tastes and textures, which are typical of a geographic zone.

The invention relates further to the use of such a leaven to provide fermented foodstuffs produced from that leaven with a varied, balanced and living microbial flora.

The invention relates further to the use of such a leaven in the preparation of a dietary probiotic comprising diversified living microorganisms, capable of limiting the development of harmful microorganisms, especially opportunistic pathogenic microorganisms.

The invention relates further to the use of such a leaven in homogeneous, reproducible cheese production with a high production yield.

In the following:
the expression “raw milk” denotes not only a milk which has not undergone treatment at a temperature higher than the temperature of the milk on leaving the udder but also, more broadly, a milk which has not undergone physical or thermal treatment capable of removing or destroying microbiological germs. It is known that the raw milk produced by healthy animals is substantially sterile on leaving the udder, and that the flora present in the raw milk after milking is composed of exogenous microorganisms which are characteristic of the environment in which the raw milk is produced.
the expression “useful flora” denotes the totality of the raw milk flora which is involved in the maturation, acidification and coagulation of the raw milk and in the development of the surface flora. The useful flora, which is also called cheese flora or technological flora, includes, for example and without implying any limitation, lactococci, especially Lactococcus cremoris, Lactococcus diacetylactis, lactobacilli and bacteria of the genus Leuconostoc.
the expression “harmful flora” denotes the totality of the milk flora which contributes to spoiling either the organoleptic properties (spoilage flora) or the sanitary quality (pathogenic flora) of the final milk product. The spoilage flora includes especially the Pseudomonas family and coliform bacteria in general. The pathogenic flora includes coagulase-positive staphylococci, especially Staphylococcus aureus, the Listeria family, especially Listeria monocytogenes, salmonellae and Escherichia coli.

Accordingly, the invention relates to a method for preparing a leaven, in which:
a raw milk is chosen from the group consisting of raw milks whose pH, in a step, called the selection step, of stabilising fermentation by acidifying lactic fermentation of the raw milk at least one temperature, called the selection temperature, of from 20° C. to 42° C., is capable of reaching a value of 5.5 in more than 15 hours and a minimum value of 5.0 in less than 48 hours, and then
a raw milk stabilisation treatment is carried out, said treatment comprising at least one step, called the stabilising fermentation step, of acidifying lactic fermentation of a fermentation medium, including a first stabilising fermentation step carried out using a fermentation medium comprising said raw milk, in which at least one stabilising fermentation step of said treatment is interrupted when the pH of the fermentation medium reaches a value of from 4.6 to 6.0—especially a value of from 4.9 to 5.6—in particular a value in the region of 5.2.

The raw milks produced on dairy farms that comply with the sanitary standards currently in force have a microbiological density which, taken as a whole, is low, especially a microbiological density which is substantially lower than that of the raw milks produced on dairy farms that do not comply with those sanitary directives. However, such raw milks having a microbiological density which, taken as a whole, is low nevertheless contain a microbiological flora which is sufficiently numerous and diversified to permit the preparation of leavens, having a diversified flora, which are capable of typing the products obtained from such leavens.

The inventors have found that, whatever their origin and their nature, the majority of the raw milks produced on such dairy farms can advantageously be enriched with useful flora by means of a stabilisation treatment comprising at least one stabilising fermentation step in which the acidifying lactic fermentation is interrupted when the pH of the fermentation medium reaches a value of from 4.6 to 6.0—especially a value of from 4.9 to 5.6—in particular a value in the region of 5.2.

Moreover, that stabilisation treatment not only allows the microbiological titre of the fermentation medium to be increased, but also enables the development of useful flora in the fermentation medium to be promoted at the expense of the spoilage flora and pathogenic flora of said fermentation medium.

The inventors have found, surprisingly, that interrupting the acidifying lactic fermentation when the pH of the fermentation medium reaches a value of from 4.6 to 6.0—especially a value of from 4.9 to 5.6—in particular a value in the region of 5.2, allows the growth of the heterofermentative microorganisms of the useful flora of the fermentation medium to be promoted, whatever the origin and nature of the raw milk, while the growth of the strict acidophilic microorganisms is limited. Furthermore, such an interruption allows the respective growth rates of the different flora present in the fermentation medium to be modified in a differential manner and enables the fermentation medium to be enriched with diversified cheese flora derived from the raw milk.

The inventors have observed that it is possible to choose the raw milks that can be used for the preparation of a leaven according to the invention by carrying out an acidifying lactic fermentation at a temperature, called the selection temperature, suitable for permitting the growth of the flora of the raw milk, said selection temperature being from 20° C. to 42° C., especially in the region of 27° C., and by selecting the fermented milks whose pH reaches a value of 5.5 in more than 15 hours and a minimum value of 5.0 in less than 48 hours. There are thus selected raw milks whose flora is diversified and suitable for effecting slow acidification of the raw milk at least one selection temperature.

Advantageously and according to the invention, that step of identifying and selecting the raw milks that can be used for the preparation of a leaven is carried out at a selection temperature in the region of 27° C., especially at a temperature of 27° C., so as to select the raw milks rich in mesophilic flora having that dual property of slow and stabilising acidification. The milk so selected is a raw milk rich in mesophilic flora which, at the selection temperature of 27° C., permit slow acidification of a fermentation medium of a first stabilising fermentation step according to the invention.

Such a method according to the invention can be described as a “bionative” method. It benefits from the biodiversity of the milk and, in particular, from the biodiversity of the native raw milk. By extension, such a leaven according to the invention obtained by a “bionative” method according to the invention will be described as a “native leaven”.

Advantageously and according to the invention, said first stabilising fermentation step is carried out without artificially adding or removing microbiological species to/from the raw milk. In particular, each stabilising fermentation step is carried out without artificially adding or removing microbiological species to/from the raw milk.

Advantageously and according to the invention, each stabilising fermentation step is carried out at a predetermined temperature of from 18° C. to 35° C., especially at a predetermined temperature of from 23° C. to 30° C., in particular at a predetermined temperature in the region of 27° C. Advantageously, each stabilising fermentation step is carried out at a predetermined temperature of 27° C. The inventors have observed that a predetermined temperature of from 18° C. to 35° C., especially a predetermined temperature of from 23° C. to 30° C., in particular a predetermined temperature in the region of 27° C., is suitable for promoting the growth of the mesophilic microorganisms in the fermentation medium, especially of the heterofermentative mesophilic microorganisms of the useful flora. More particularly, such a predetermined temperature of a stabilising fermentation step is suitable for permitting a reduction in the proportion of spoilage flora relative to the total flora in the fermentation medium. Yet more particularly, such a predetermined temperature of a stabilising fermentation step is suitable for promoting the thermotolerant flora having optimum growth conditions similar to the growth conditions of the thermophilic flora and increasing the biodiversity of the flora of the fermentation medium.

Advantageously and according to the invention, the first stabilising fermentation step is interrupted after an acidifying lactic fermentation time of the fermentation medium of from 12 hours to 36 hours, in particular from 17 hours to 24 hours.

The inventors have observed that the slow acidification of a fermentation medium during a first stabilising fermentation step, in particular an acidification allowing the pH of the fermentation medium to be reduced to a value of from 4.6 to 6.0—especially to a value of from 4.9 to 5.6—in particular to a value in the region of 5.2, in more than 12 hours and in less than 36 hours, especially in more than 17 hours and in less than 24 hours, allows the flora constituting the fermentation medium to be amplified.

In the present case, the inventors have observed that amplifying the flora constituting the fermentation medium in a first stabilising fermentation step does not lead to the selection of a small number of microbiological species of the fermentation medium (nor, therefore, to a reduction in the number of microbiological species present in said fermentation medium) but, on the contrary, to the growth of the major part of the microbial species initially present in the fermentation medium.

Furthermore, such a step of stabilising fermentation of a fermentation medium formed of a raw milk allows the relative proportions of the different microbiological species present in the fermentation medium to be modified while retaining the major part of the microbiological species constituting the useful flora necessary for the preparation of a leaven whose biodiversity is representative of the biodiversity of the microbiological flora constituting the raw milk from which it was prepared.

Advantageously and according to the invention, the fermentation medium of the first stabilising fermentation step is a raw milk derived from a mammal, especially a raw milk chosen from the group consisting of raw milk derived from a cow, raw milk derived from a ewe, raw milk derived from a goat and raw milk derived from a buffalo. In particular, the fermentation medium of a first stabilising fermentation step is a raw milk derived from animals of the class of the mammals, with the exception of milks derived from animals belonging to the order of the monotremes.

The inventors have in fact observed that the slow acidification of a fermentation medium formed of a raw milk, in a first stabilising fermentation step, in particular acidification allowing the pH of the fermentation medium to be reduced to a value of from 4.6 to 6.0—especially to a value of from 4.9 to 5.6—in particular to a value in the region of 5.2, in more than 12 hours and in less than 36 hours, especially in more than 17 hours and in less than 24 hours, allows the major part of the flora—especially the useful flora—constituting the raw milk to be amplified.

In particular, such a step of slow stabilising fermentation of a fermentation medium formed of a raw milk allows the proportion of spoilage flora in milks rich in spoilage flora to be reduced in favour of diversified useful flora in the fermentation medium having a pH of substantially from 4.6 to 6.0—especially having a value of from 4.9 to 5.6—in particular having a value in the region of 5.2, obtained at the end of a first stabilising fermentation step of a stabilisation treatment.

There is no clear explanation for this surprising result. The inventors think that it may be due, at least in part, to the fact that the slow acidification of a fermentation medium formed of a raw milk generates, during the slow acidification, varied physicochemical conditions which are capable of permitting the growth of the useful flora and permitting the establishment of a stable equilibrium between all the microbiological species constituting the fermentation medium.

Furthermore, the amplification of the major part of the microbiological species of the useful flora in the fermentation medium in a first stabilising fermentation step is also accompanied by an increase in the proportion of coliform bacteria, especially pathogenic bacteria of the genus Escherichia coli, in said fermentation medium. The inventors have observed, surprisingly, that the proportion of coliform bacteria, especially pathogenic bacteria of the genus Escherichia coli, in the fermentation medium at the end of the first stabilising fermentation step decreases in the fermentation media formed at the end of the subsequent stabilising fermentation steps.

Advantageously and according to the invention, the fermentation medium of the first stabilising fermentation step contains living microorganisms in a concentration of from 5 10³ to 5 10⁵ living microorganisms/ml. In particular, it is possible for the fermentation medium of the first stabilising fermentation step to be a clean raw milk, that is to say a raw milk containing in the region of 10⁴ living microorganisms/ml. It is also possible for the fermentation medium of the first stabilising fermentation step to be a raw milk containing more than 10⁵ living microorganisms/ml, especially in the region of 2 10⁵ living microorganisms/ml. It is also possible for the fermentation medium, formed of a raw milk, of the first stabilising fermentation step to be an ultra-clean raw milk containing less than 10⁴ living microorganisms/ml, especially in the region of 5 10³ living microorganisms/ml. In general, the fermentation medium, formed of a raw milk, of the first stabilising fermentation step is a raw milk that is free of pathogenic microorganisms of the genera Listeria and Salmonella.

Advantageously and according to the invention, at least two—especially six—successive stabilising fermentation steps are carried out, each stabilising fermentation step being interrupted (an interruption of the fermentation being carried out between the two successive steps). In particular, after a first step of stabilising fermentation of a raw milk, a succession of several subsequent stabilising fermentation steps of a treatment according to the invention is carried out in order to deplete the fermentation medium of spoilage flora, coliform flora and bacteria of the genus Escherichia coli and enrich the fermentation medium with useful flora. In particular, the inventors have observed that by carrying out six successive stabilising fermentation steps using a raw milk it is possible to obtain, at the end of the six stabilising fermentation steps, a fermentation medium whose pH value is substantially from 4.6 to 6.0—especially from 4.9 to 5.6—in particular in the region of 5.2—and which contains a proportion of in the region of several microorganisms, especially from 1 to 10 microorganisms, belonging to the spoilage flora per 10⁶ total microorganisms. By way of variation, and advantageously, at least ten successive stabilising fermentation steps are carried out using a raw milk, the number of successive stabilising fermentation steps being adapted to obtain such a proportion of spoilage flora relative to total flora.

The inventors have found, surprisingly, that the increase in the proportion of coliform bacteria, especially pathogenic bacteria of the genus Escherichia coli, relative to total flora, simultaneously with the reduction in the proportion of spoilage flora, in the fermentation medium, formed of a raw milk, of a first stabilising fermentation step is a characteristic proper to that first step of stabilising fermentation of a fermentation medium formed of a raw milk. In fact, in subsequent stabilising fermentation steps of a stabilisation treatment, the proportion of coliform bacteria, especially pathogenic bacteria of the genus Escherichia coli, relative to total flora falls in the successive fermentation media of the subsequent stabilising fermentation steps until it reaches, for example, a value below 0.01%, especially in the region of 0.001%, or even a non-detectable quantity of pathogenic germs of the genus Escherichia coli. Accordingly, in the fermentation medium of a subsequent stabilising fermentation step of a stabilisation treatment, the total number of microorganisms reaches a value in the region of 2 10⁹ microorganisms/ml, while the proportion of bacteria of the genus Escherichia coli relative to total flora falls until it reaches a value below 0.01%, especially in the region of 0.001%, in particular a value of zero.

It is to be noted that this proportion of bacteria of the genus Escherichia coli relative to total flora in a fermentation medium of a subsequent stabilising fermentation step is substantially less than the proportion of the same bacteria of the genus Escherichia coli relative to total flora in a raw milk.

The inventors have observed that, in a fermentation medium of a subsequent stabilising fermentation step, the proportion of Escherichia coli bacteria in the fermentation media of subsequent successive stabilising fermentation steps falls until it reaches a proportion of in the region of a few bacteria of the genus Escherichia coli per 10⁶ total microorganisms.

In a fermentation medium of a subsequent stabilising fermentation step, the proportion of coliforms, staphylococci, yeasts and moulds falls in successive stabilising fermentation steps until those species are no longer detectable in the fermentation medium of a final stabilising fermentation.

In particular, the inventors have observed that carrying out a plurality of successive stabilising fermentation steps results in the stabilisation of a complex ecosystem which is formed of the living microorganisms constituting the useful flora of the raw milk and the composition of which is diversified and stable. Even more surprisingly, the inventors have found that carrying out a plurality of successive stabilising fermentation steps results in an ecosystem that is substantially free of spoilage flora and pathogenic flora.

Accordingly, unlike a coculture ferment formed of a small number of microorganism strains, especially one, two or three microorganism strain(s), which does not stabilise in an identical manner in successive subcultures and tends towards the selection of a single strain which develops alone within the ecosystem, the method according to the invention permits the stabilisation of a complex ecosystem containing several tens of different microorganism strains derived from the raw milk, and containing in particular the major part of the useful flora of said raw milk.

In particular, the inventors have observed that the acidification kinetics of the fermentation media of the successive subsequent stabilising fermentation steps of a stabilisation treatment exhibit substantially similar profiles. In particular, the profiles exhibit a lag phase, the duration of which is substantially retained from one step to another, and a rapid acidification phase, the absolute maximum value of the gradient of which is substantially retained from one step to another.

Advantageously and according to the invention, each stabilising fermentation step is interrupted by cooling the fermentation medium to a temperature below +4° C., especially to a temperature of from 0° C. to +4° C. The acidifying lactic fermentation of said fermentation medium is accordingly interrupted without adding a substance aimed at modifying the physicochemical, especially acido-basic, and biological properties of said fermentation medium. Such a temperature of from 0° C. to +4° C. is suitable for permitting rapid cooling of the fermentation medium obtained in the fermentation step and for conserving substantially all the revivification potential of the flora contained in the medium. Such a cooling temperature of the fermentation medium is further suitable for avoiding the preferential growth of psychrophilic microorganisms during cooling and storage of the fermentation medium.

Advantageously and according to the invention, at least one step, called the subsequent stabilising fermentation step, is carried out after the first stabilising fermentation step, using a fermentation medium formed of a quantity of a liquid culture medium and a quantity of a fermentation medium, called the preceding fermentation medium, obtained at the end of a preceding stabilising fermentation step, in a ratio by volume of the quantity of preceding fermentation medium to the quantity of fermentation medium of from 0.5% to 25%, especially from 1% to 5%, in particular in the region of 2%.

Advantageously and according to the invention, the liquid culture medium is a sterilised and osmosed lactose-containing liquor having a solids content of from 4 to 20 wt. %, especially 12 wt. %. A sterilised and osmosed lactose-containing liquor according to the present invention is a sterilised liquid, containing lactose, whose saline and vitamin natures are balanced. In particular, the liquid culture medium is chosen from the group consisting of milks of natural origin, standardised milks and reconstituted milks, capable of undergoing acidification by lactic bacteria. More particularly, the liquid culture medium is a milk of natural origin chosen from the group consisting of pasteurised milks, thermised milks and microfiltered milks or any other milk of natural origin.

Advantageously and according to the invention, the pH of the liquid culture medium is from 6.5 to 7.0, especially substantially in the region of 6.6. The inventors have observed that a culture medium formed of a milk having a solids content of from 4 to 20 wt. % has a sufficient buffering capacity to permit substantially the neutralisation of the acidity of the fermentation medium obtained by mixing a quantity of the liquid culture medium and a quantity of the preceding fermentation medium whose pH value is from 4.6 to 6.0—especially from 4.9 to 5.6—in particular in the region of 5.2, of a preceding stabilising fermentation step.

Advantageously and according to the invention, said preceding fermentation medium has a pH value of from 4.6 to 6.0—especially from 4.9 to 5.6—in particular in the region of 5.2, and contains from 5 10⁷ to 5 10⁹ microorganisms/ml.

Furthermore, advantageously and according to the invention, the raw milk is chosen from the group consisting of raw milks containing more than 5.10³ mesophilic microorganisms/ml, the selected raw milk is subjected to a first stabilising fermentation step of a stabilisation treatment, and said step is interrupted when the pH of the fermentation medium reaches a value of from 4.6 to 6.0—especially from 4.9 to 5.6—in particular a value in the region of 5.2.

Advantageously and according to the invention, the raw milk is chosen from the group consisting of raw milks whose pH, during a step, called the selection step, of stabilising fermentation by acidifying lactic fermentation of the raw milk at the selection temperatures of 27° C. and of 40° C., is capable of reaching a value of 5.5 in more than 15 hours and a minimum value of 5.0 in less than 48 hours.

Advantageously, the raw milk is chosen from the group consisting of raw milks whose pH, during a step, called the selection step, of stabilising fermentation by acidifying lactic fermentation of the raw milk at two selection temperatures of from 20° C. to 40° C., is capable of reaching a value of 5.5 in more than 15 hours and a minimum value of 5.0 in less than 48 hours.

Said step of selection of the raw milk is carried out at two temperatures, especially 27° C. and 40° C., in order to select raw milks that are rich in mesophilic and/or thermophilic flora.

Furthermore, advantageously and according to the invention, prior to the first stabilising fermentation step of a stabilisation treatment, a raw milk is chosen from the group consisting of raw milks that are substantially free of pathogenic microorganisms, especially of the genus Salmonella, of the genus Listeria, in particular the species Listeria monocytogenes. In particular, the raw milk is selected from the group consisting of raw milks whose content of pathogenic microorganisms is below the threshold defined by sanitary standards, especially milks capable of forming less than one colony of pathogenic microorganisms per 25 g of tested raw milk on a solid culture medium.

Advantageously, a leaven is produced exclusively from raw milk without artificially adding or removing microbiological species to/from the raw milk, by a method according to the invention which allows the staphylococci, yeasts and moulds to be removed from the leaven and which further allows the proportion of hygiene flora, especially the proportion of coliform flora, to be reduced considerably or even removed completely from the leaven.

The invention therefore relates to a leaven derived from raw milk:
containing more than 10⁷ microorganisms/ml, especially from 5.10⁷ to 5.10⁹ microorganisms/ml, and
containing from 5 to 100 different microbiological species and sub-species, especially from 5 to 30 identifiable species and sub-species, in particular from 5 to 12 identifiable microbiological species and sub-species, said microbiological species and sub-species being derived from the raw milk solely by spontaneous fermentation thereof (without adding leaven or artificially removing microbiological species),
   and in which more than 80% of the microbiological species and sub-species contained in the leaven are derived from the useful flora of the raw milk.

By way of variation, advantageously and according to the invention, the leaven is substantially free of coliforms, Escherichia coli and staphylococci.

Advantageously, a leaven according to the invention contains microorganisms in a concentration greater than 10⁷ microorganisms/ml, especially a concentration of from 5.10⁷ to 5.10⁹ microorganisms/ml, said microorganisms belonging to microbiological species and sub-species derived in totality from the raw milk, that is to say without artificially adding or removing microbiological species to/from the raw milk.

Advantageously, the leaven contains from 5 to 100 different microbiological species and sub-species, especially from 5 to 30 microbiological species and sub-species which are identifiable by biochemical, microbiological or genetic means known per se. In particular, the leaven contains from 5 to 12 identifiable microbiological species and sub-species which are derived from the raw milk solely by spontaneous fermentation thereof, without artificially adding or removing microbiological species to/from the leaven.

The microbiological analyses of the leaven obtained by a method according to the invention are carried out by any means known per se. In particular, such analyses are carried out by microbiological cell counting means, especially by culturing the leaven on solid culture media and counting the colonies formed. To that end there are used solid culture media whose composition allows the different microbiological species to be selected as a function of their trophic requirements. Furthermore, such cultures are carried out at different temperatures suitable for meeting the optimal thermal growth demands of the flora of the leaven. Such cultures are further carried out under various aeration conditions capable of permitting the growth of aerobic microorganisms, of strict anaerobic microorganisms, of aero-tolerant anaerobic microorganisms.

The analyses of the microbiological composition and of the biodiversity of the leaven obtained by a method according to the invention are carried out by molecular techniques of amplification, separation and qualitative and quantitative analysis of the nucleic acids, especially DNA, of the various microbiological species constituting the leaven according to the invention, especially by polymerase chain reaction (PCR) techniques.

The invention relates further to a leaven obtainable from a raw milk by a method according to the invention.

The invention relates further to the use of a leaven according to the invention in the preparation of fermented specialities. The use of such a leaven allows organoleptic characteristics, especially taste and texture characteristics, similar to those formed from raw milk to be imparted to the fermented speciality. Such a use further permits a harmonious development of the product during its ripening. Furthermore, the use of such a leaven allows the best-before date of the product produced from the leaven to be extended by providing the product with a diversified microbiological composition suitable for preventing, by means of a barrier effect, any contamination following preparation of the product. Such a diversified microbiological composition, provided during the method of producing a fermented milk product, is suitable for preventing the development of a majority, or even a single, microbiological species capable of diverting the totality of the available substrate to the benefit of its development. In particular, the use of such a leaven makes it possible to avoid the unpleasant production of ammonia by favouring healthy ripening flora.

The use of such a leaven is suitable for permitting an increase in the water content associated with the fermented speciality relative to the free water thereof, imparting to said speciality stability over time, an advantageous texture and, during ripening in the cellar or in packaging, controlled and smaller losses of water. Such small and controlled losses of water generate increases in the production yield of said speciality and an economic value.

The invention relates further to the use of a leaven according to the invention in the preparation of a fermented milk product, in which fermentation of a raw milk is carried out. In particular, such a leaven according to the invention is used in the cheese industry in the preparation of a fermented milk product of the “cooked body” type, a fermented milk product of the “pressed body” type, a fermented milk product of the “soft body” type, a fermented milk product of the “lactic body” type, a fermented milk product of the “blue-veined body” type, yoghurts, fermented milks and butter.

The invention relates further to the use of a leaven according to the invention in the preparation of a fermented milk product, in which a milk chosen from the group consisting of raw milks, raw milks that have undergone thermal treatment—especially pasteurised milks and thermised milks—, raw milks that have undergone athermal treatment—especially microfiltered milks—, reconstituted milks and standardised milks is fermented.

In particular, the use of a leaven according to the invention in the preparation of a fermented milk product from pasteurised, thermised or microfiltered milk advantageously permits the production of a fermented milk product containing pasteurised, thermised or microfiltered milk that has organoleptic properties similar to the organoleptic properties of a milk product containing raw milk.

The use of a leaven according to the invention, obtained in the stabilisation treatment, further permits an increase in the reproducibility of the methods for preparing fermented milk products by stabilisation of the microbiological composition. Furthermore, the use of such a leaven, having a complex composition, makes it possible to protect the product from an evolution of its maturation that is associated with a single microbiological species. The use of such a leaven further permits an increase in the quantity of water associated with the fermented milk product and accordingly an increase in the production yield of the product.

The use of a biodiversified leaven according to the invention is suitable in particular for opposing the development and/or stopping the growth of hygiene and/or pathogenic bacteria in a production area of a fermented milk product, in the fermented milk product itself during its evolutive conservation. Such a protective effect is further suitable for preventing the development of hygiene and/or pathogenic bacteria in the intestinal flora during digestion of the fermented milk product according to the invention.

The invention relates also to a method for preparing a leaven, to a leaven and to its use, characterised in combination by all or some of the features mentioned hereinabove or hereinbelow.

Other objects, features and advantages of the invention will become apparent upon reading the following description, which refers to the accompanying figures showing preferred embodiments of the invention, given solely by way of non-limiting examples, and in which:

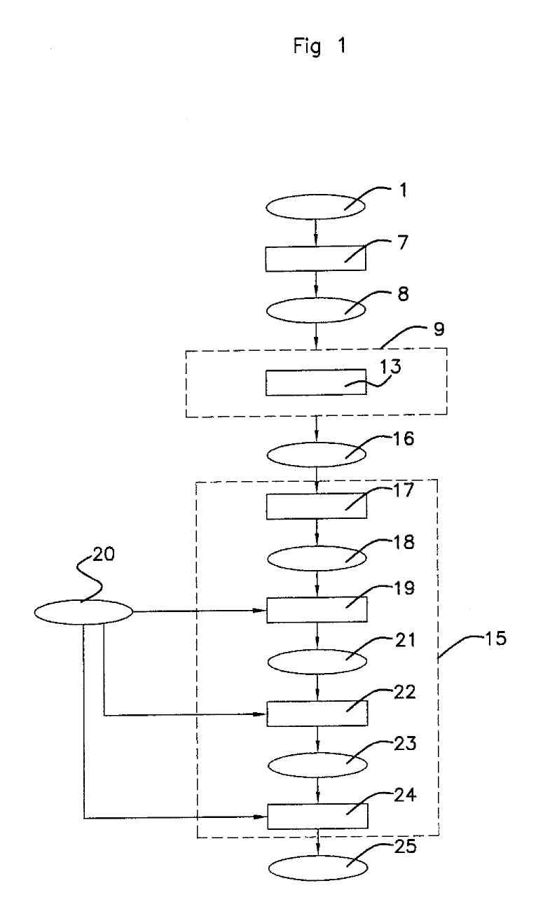

FIG. 1 is a flow chart showing a method according to the invention,

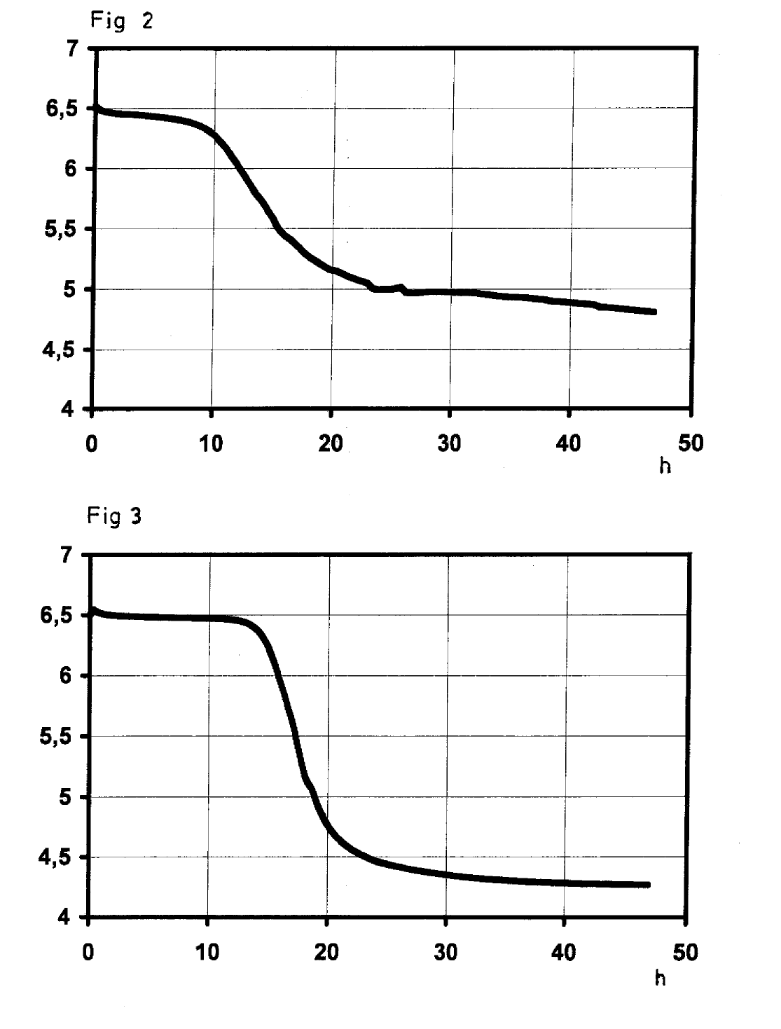

FIG. 2 is a graphic representation of the change over time in the pH of a fermentation medium formed of a raw milk containing in the region of 2 10⁵ microorganisms/ml of a first stabilising fermentation step at 27° C. of a method according to the invention,

FIG. 3 is a graphic representation of the change over time in the pH of a fermentation medium formed of a raw milk containing in the region of 1.1 10⁴ microorganisms/ml of a first stabilising fermentation step at 27° C. of a method according to the invention,

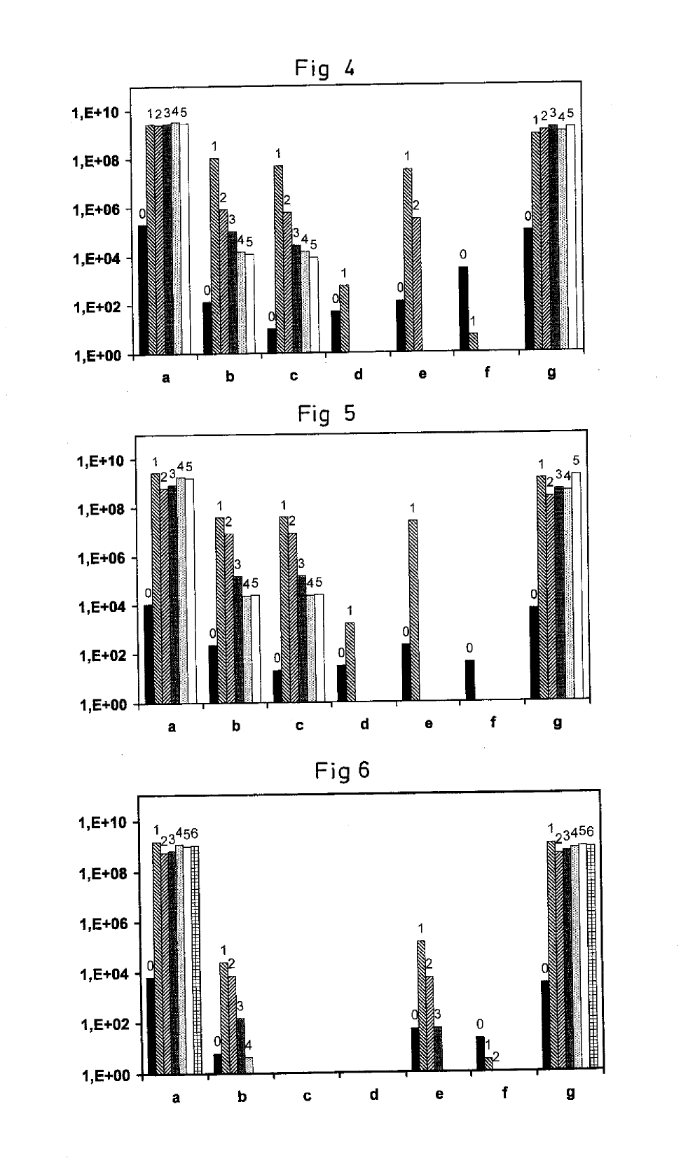

FIG. 4 is a bar chart showing the microbial composition of the successive fermentation media of a stabilisation treatment of a raw milk containing in the region of 2.0 10⁵ microorganisms/ml,

FIG. 5 is a bar chart showing the microbial composition of the successive fermentation media of a stabilisation treatment of a raw milk containing in the region of 1.1 10⁴ microorganisms/ml,

FIG. 6 is a bar chart showing the microbial composition of the successive fermentation media of a stabilisation treatment of a raw milk containing in the region of 6.5 10³ microorganisms/ml,

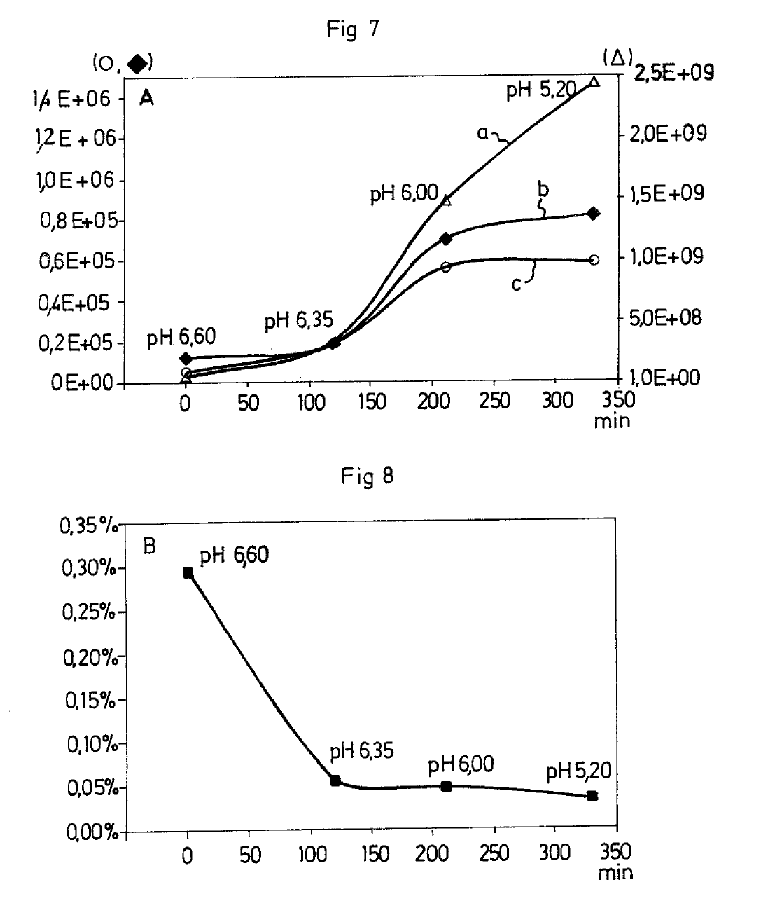

FIG. 7 is a graphic representation of the change over time in the microbial composition of a fermentation medium of a third stabilising fermentation step of a stabilisation treatment of a raw milk containing in the region of 2.0 10⁵ microorganisms/ml according to the invention,

FIG. 8 is a graphic representation of the change over time in the percentage of spoilage flora in a fermentation medium of a third stabilising fermentation step of a stabilisation treatment according to the invention of a raw milk containing in the region of 2.0 10⁵ microorganisms/ml,

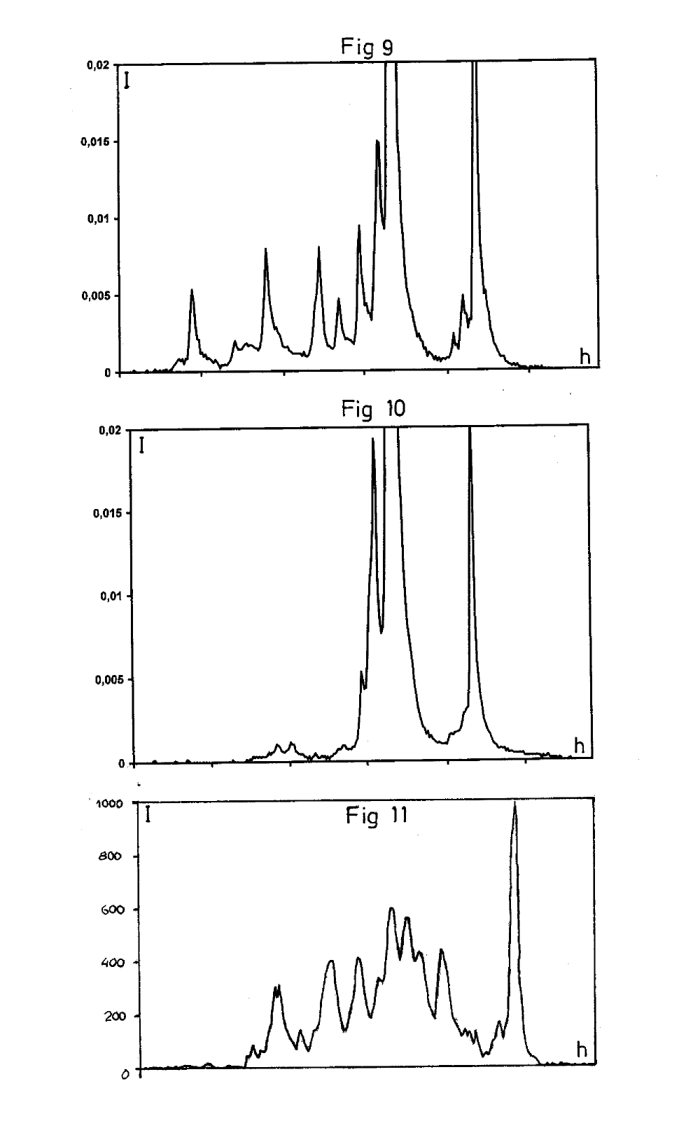

FIG. 9 is a graphic representation of an electrophoretic analysis profile of the microbiological constituents of a leaven according to the invention,

FIG. 10 is a graphic representation of an electrophoretic analysis profile of the microbiological constituents of a leaven obtained from coculture,

FIG. 11 is a graphic representation of an electrophoretic analysis profile of the microbiological constituents of a raw milk.

An embodiment of a method for preparing a leaven according to the invention is shown in the flow chart of FIG. 1. A sample 7 of a quantity of raw milk is taken from a dairy farm of a group 1 of dairy farms representing a “terroir”. The totality of the samples 7 of the raw milks constitutes a collection 8 of raw milk samples. The sample 7 is taken after milking, especially within a period of less than 12 hours after milking, and the sampled quantity of milk is subjected directly to a cooling treatment suitable for preserving, in the long-term, the composition of the living flora constituting the raw milk. In particular, the cooling treatment of a volume of the raw milk is carried out at a temperature of +4° C. The volume of raw milk subjected to the cooling treatment is suitable for permitting rapid cooling, especially in less than 1 hour, of that volume of raw milk. The volume of raw milk subjected to the cooling treatment is in particular in the region of 1 litre.

There is then carried out a step 9 of evaluating the various raw milks of the collection 8 of raw milks in order to identify and select the raw milks that are capable of permitting the preparation of a leaven according to the invention. The step 9 of evaluating the raw milks of the collection 8 comprises at least one step 13 of selection of the raw milks, in which acidifying lactic fermentation of the raw milk is carried out at least one selection temperature and at the end of which the milks in which the pH of the fermentation medium has reached a value of 5.5 in more than 15 hours and a minimum value of 5.0 in less than 48 hours are retained. In particular, there is carried out in parallel a step 13 of selection of a raw milk at a temperature of 27° C. and/or at a temperature of 40° C., and the raw milk(s) in which the pH of the acidifying lactic fermentation medium at 27° C. and/or at 40° C. has reached a value of 5.5 in more than 15 hours and a minimum value of 5.0 in less than 48 hours at 27° C. and at 40° C. is(are) retained. The potential of the raw milks of the collection 8 of raw milks to induce a fall in the pH of a fermentation medium, by acidifying lactic fermentation, which is slow and nevertheless stabilising is thus evaluated. The step 13 of selecting raw milk is carried out in a reactor suitable for permitting measurement, especially continuous measurement, of the pH of the fermentation medium. In particular, the selection step 13 is carried out in a fermenter which allows the temperature of the fermentation medium to be maintained at a preselected temperature. The selection step 13 is carried out with stirring of said fermentation medium. However, such stirring, which is suitable for homogenising the fermentation medium, is not suitable for permitting aeration of the fermentation medium. Accordingly, the acidifying lactic fermentation takes place substantially under anaerobiosis conditions.

In a first stabilising fermentation step 17 of a stabilisation treatment 15, a fermentation medium formed of a preselected raw milk 16 is subjected to acidifying lactic fermentation at a temperature of 27° C., and said acidifying lactic fermentation is interrupted when the pH of the fermentation medium reaches a value of 5.2 in more than 12 hours and in less than 24 hours. Said acidifying lactic fermentation is interrupted by cooling the fermentation medium to a temperature in the region of +4° C. At the end of the first stabilising fermentation step 17 there is obtained a fermentation medium formed of a fermented milk 18 whose pH is in the region of pH 5.2, whose temperature is in the region of +4° C., and whose microbiological flora is enriched compared with the flora of the starting raw milk.

In a second, subsequent stabilising filtration step 19 there is prepared a fermentation medium of a second stabilising fermentation step, which fermentation medium is formed of a mixture of a quantity of the fermented milk 18 and a quantity of a liquid culture medium 20, so that the proportion by volume of fermented milk 18 in the fermentation medium of a second stabilising fermentation step is in the region of 2%. The fermentation medium of said second stabilising filtration step is subjected to acidifying lactic fermentation at 27° C., and the acidifying lactic fermentation is interrupted when the pH of the fermentation medium of the second stabilising fermentation step reaches a value of 5.2. Said acidifying lactic fermentation is interrupted by cooling to +4° C. the fermentation medium at pH 5.2 of the second stabilising fermentation step.

In this embodiment of a method according to the invention, a plurality of successive stabilising fermentation steps is carried out, and the fermentation medium of each stabilising fermentation step is formed of a quantity of a liquid culture medium 20 and a quantity of a fermentation medium at pH 5.2 derived from a preceding stabilising fermentation step.

Accordingly, in successive subsequent stabilising fermentation steps 22 and 24 there is prepared a fermentation medium for a subsequent stabilising fermentation step of a stabilisation treatment 15, which fermentation medium is formed of a mixture of a quantity of a fermentation medium 21 or 23 at pH 5.2 with a quantity of a liquid culture medium 20 so that the proportion by volume of the fermentation medium 21, 23 at pH 5.2 in the fermentation medium of a subsequent stabilising fermentation step is in the region of 2%. The fermentation medium of a subsequent stabilising fermentation step is subjected to acidifying lactic fermentation at 27° C., and the acidifying lactic fermentation is interrupted when the pH of the fermentation medium of the subsequent stabilising fermentation step reaches a value of 5.2. Said acidifying lactic fermentation is interrupted by cooling the fermentation medium of the subsequent stabilising fermentation step to a temperature substantially in the region of +4° C.

The fermentation medium obtained at the end of stabilising fermentation step 24 is a leaven 25 containing a high concentration of microorganisms, especially in the region of 2 10⁹ microorganisms/ml, and containing the major part of the microbiological species constituting the useful flora of the selected raw milk 16.

In a second embodiment (not shown) of a method according to the invention, it is possible to carry out, after stabilising fermentation step 24, a plurality of—especially one or two—additional subsequent stabilising fermentation steps of a stabilisation treatment 15 by subjecting a fermentation medium formed of a quantity of a stabilising fermentation medium at pH 5.2 of a prior stabilising fermentation step of the stabilisation treatment 15, and of a quantity of a culture medium 20 to acidifying lactic fermentation at 27° C. and interrupting said acidifying lactic fermentation when the pH of the fermentation medium reaches a value of 5.2. Said acidifying lactic fermentation is interrupted by cooling the fermentation medium of the stabilising fermentation step to a temperature substantially in the region of +4° C.

In a third embodiment (not shown) of a method according to the invention there are used for the preparation of the fermentation media of the successive stabilising fermentation steps of a stabilisation treatment 15 culture media 20 having different compositions, which are mixed with a quantity of a fermentation medium derived from a preceding stabilising fermentation step.

### EXAMPLE 1

### Preparation of a Leaven from a Raw Milk Containing in the Region of 2 10⁵ Living microorganisms/ml

A cow's raw milk is chosen from a dairy farm which forms part of a “terroir” and was selected beforehand in view of the breeding conditions of the cattle, especially from a dairy farm which advocates a system of permanent pasture. 1 litre of milk is taken and stored at +4° C. until the stabilisation treatment. The milk has a high FMAR (revivifiable aerobic mesophilic flora) count in the region of 2 10⁵ microorganisms/ml. The milk is placed at a temperature of 27° C., with stirring, in a fermenter suitable for permitting lactic fermentation of the raw milk. In particular, the lactic fermentation is carried out in a fermenter suitable for allowing the pH of the fermentation to be measured.

FIG. 2 shows the change in the pH of a fermentation medium, formed of a raw milk containing in the region of 2 10⁵ microorganisms/ml, of a first stabilising fermentation step of a stabilisation treatment at 27° C. according to the invention. FIG. 2 shows said change in the pH of the fermentation medium of said first stabilising fermentation step at 27° C. when the acidifying lactic fermentation is not interrupted when the pH of said fermentation medium reaches a value in the region of 5.2. The duration of the lag phase of the acidification curve, defined as the early part of the kinetics during which the pH value is substantially invariant, is in the region of 10 hours. The pH of the fermentation medium reaches a value of 6.0 after an acidifying lactic fermentation time of 12 hours, a value of 5.2 after 18 hours and a value of 4.9 after 24 hours. The pH of the fermentation medium stabilises at a value in the region of 4.4 after approximately 30 hours'fermentation. Accordingly, in order to carry out a method according to the invention, the fermentation medium of the first stabilising fermentation step is a raw milk and the acidifying lactic fermentation of the fermentation medium is advantageously interrupted when the pH of the fermentation medium reaches 5.2, especially in this example after 18 hours.

FIG. 4 shows, by way of a non-limiting example, the change in the composition of the revivifiable aerobic mesophilic flora (FMAR) (a), the coliform flora (b), Escherichia coli (c), staphylococci (d), yeasts (e), moulds (f) and the useful flora (g) of the fermentation medium during the successive steps of a stabilisation treatment of a raw milk containing in the region of 2 10⁵ microorganisms/ml according to the invention. The analysis corresponding to series 0 of FIG. 4 (solid bars) represents the microbiological count of the starting raw milk. The analyses corresponding to series 1, 2, 3, 4 and 5 of FIG. 4 represent the microbiological counts of the fermentation medium at pH 5.2 of the first, second, third, fourth and fifth stabilising fermentation steps, respectively, of a stabilisation treatment according to the invention.

The numerical values corresponding to those counts are given in Table 1 below. The microbiological composition of the useful flora (g) is detailed in Table 1 and brings together the totality of the streptococci (h), the lactococci (i), the lactobacilli (j) and the leuconostoc (k).

TABLE 1

| | | | | | | | g | | | |
|---|---|---|---|---|---|---|---|---|---|---|
| | a | b | c | d | e | f | h | I | j | k |
| 0 | 2.04E+5 | 1.3E+2 | 1.0E+1 | 5.0E+1 | 1.3E+2 | 2.8E+3 | 8.4E+3 | 4.08E+4 | 4.4E+3 | 4.24E+4 |
| 1 | 2.70E+9 | 1.06E+8 | 4.90E+7 | 5.66E+2 | 3.10E+7 | 5.0E+0 | 2.49E+8 | 2.6E+8 | 3.06E+8 | 4.52E+6 |
| 2 | 2.44E+9 | 8.20E+5 | 5.90E+5 | nd | 3.0E+5 | nd | 4.30E+8 | 5.5E+8 | 2.06E+8 | 8.5E+6 |
| 3 | 2.76E+9 | 1.03E+5 | 2.65E+4 | nd | nd | nd | 7.0E+8 | 7.8E+8 | 1.02E+8 | 3.0E+7 |
| 4 | 3.25E+9 | 1.50E+4 | 1.45E+4 | nd | nd | nd | 8.4E+8 | 1.08E+8 | 1.08E+8 | 1.44E+7 |
| 5 | 2.85E+9 | 1.20E+4 | 8.50E+3 | nd | nd | nd | 9.5E+8 | 4.5E+8 | 9.6E+7 | 1.13E+7 |

nd = not detectable

In the first stabilising fermentation step, the FMAR count (a) changes from an initial value (series 0) in the raw milk of 2.04 10⁵ microorganisms/ml to a final value in the successive fermentation media at pH 5.2 (series 1, 2, 3, 4 and 5) in the region of 2.80 10⁹ microorganisms/ml. The count of useful flora (g) changes from an initial value (series 0) in the raw milk of 9.6 10⁵ microorganisms/ml to a final value in the successive fermentation media at pH 5.2 (series 1, 2, 3, 4 and 5) which is stable and in the region of 1.3 10⁹ microorganisms/ml.

Furthermore, the count of coliform flora (c) increases significantly from an initial value (series 0) in the raw milk of 140 microorganisms/ml to a value in the fermentation medium at pH 5.2 (series 1) of the first stabilising fermentation step of 1.06 10⁸ microorganisms/ml, then decreases in the fermentation media of the subsequent successive stabilising fermentation steps (series 2, 3, 4 and 5) to a value in the region of 1.20 10⁴ microorganisms/ml. Accordingly, the proportion of coliform bacteria relative to the FMAR changes from a value in the region of 0.06% in the raw milk to a value in the region of 0.0004% in the leaven obtained after the fifth stabilising fermentation step, reflecting a depletion of coliform flora in the leaven.

A similar observation is made regarding Escherichia coli bacteria, the proportion of which relative to the FMAR is 1 E. coli bacterium per 2 10⁴ FMAR in the raw milk and 1 E. coli bacterium per 3 10⁶ FMAR in the fermentation medium of the fifth stabilising fermentation step.

It is further observed in FIG. 4 and Table 1 that the staphylococci (d), the yeasts (e) and the moulds (f) disappear completely from the successive fermentation media from the third stabilising fermentation step (series 4) of a stabilisation treatment according to the invention.

Furthermore, the inventors have observed that the acidification kinetics of the fermentation media of the stabilising fermentation steps of a stabilisation treatment according to the invention are similar starting from the second stabilising fermentation step. The kinetics exhibit a lag phase in the region of 150 minutes, reach a pH of 6.0 between 230 minutes and 260 minutes, a pH of 5.2 between 290 minutes and 320 minutes, and stabilise at a pH in the region of pH 4.5 after 400 minutes.

FIG. 7 shows the change in the bacterial counts during the third stabilising fermentation step of the stabilisation treatment of a raw milk containing in the region of 2 10⁵ microorganisms/ml according to the invention, conducted at a temperature of 27° C. and interrupted after 330 minutes when the pH of the fermentation medium has reached a value of 5.2. Curve (a) shows the change in the total flora (FMAR), curve (b) shows the change in the flora formed of coliforms, and curve (c) shows the change in the flora formed of Escherichia coli. It will be seen that the coliform flora and the flora formed of Escherichia coli exhibit a rate of growth which falls starting from 200 minutes (pH 6.0) of lactic fermentation, while the total flora (FMAR) exhibits a rate of growth which is not substantially slowed until pH 5.2.

FIG. 8 shows the change in the count of coliform flora, expressed as a percentage of the total flora (FMAR), in the fermentation medium of a third stabilising fermentation step of a method according to the invention. It will be seen that the proportion of coliform flora relative to the total flora of the fermentation medium at the time of seeding is 0.29% and falls to a value of 0.06% after 120 minutes' incubation (pH 6.35) and stabilises at a value of 0.03% after 330 minutes' incubation (pH 5.20).

FIG. 9 shows a molecular print showing the microbiological biodiversity of the leaven obtained by a method according to the invention from the raw milk of Example 1 containing in the region of 2 10⁵ microorganisms/ml. The profile of FIG. 9 shows two major peaks corresponding to the major lactofermentative microbiological strains of the leaven. Furthermore, the profile shows eight peaks of intermediate intensity characterising at least eight different microbiological species in the leaven according to the invention. Finally, the profile reveals a plurality of signals which are of low intensity but are characteristic of a considerable biodiversity of the leaven according to the invention produced from raw milk.

Furthermore, the analysis profile, by way of control, of a raw milk as used for the preparation of a leaven according to the invention exhibits a major peak corresponding to a lactofermentative microbiological strain of the raw milk, eight peaks of intermediate intensity, and a plurality of signals of low intensity characteristic of the biodiversity of the raw milk. This control shows that a method for preparing a leaven according to the invention allows the major part of the biodiversity of the raw milk on which the prepared leaven is based to be retained.

FIG. 10 shows, by way of comparative control, an analysis profile of a leaven obtained from coculture, showing two major peaks corresponding to the lactofermentative microbiological strains and two peaks of intermediate intensity. Furthermore, the profile does not reveal signals of low intensity indicating considerable biodiversity of the leaven.

FIG. 11 shows a DNA print of a raw milk, given by way of comparison of the respective compositions of a raw milk and of a leaven obtained by a method according to the invention. It will be seen that the DNA print of the leaven according to the invention is comparable with that of the reference raw milk, thus showing that almost all the biodiversity of the leaven has been retained relative to the raw milk.

### EXAMPLE 2

### Preparation of a Leaven from a Raw Milk Containing in the Region of 1 10⁴ microorganisms/ml

1 litre of cow's raw milk having a low FMAR (revivifiable aerobic mesophilic flora) count in the region of 1 10⁴ microorganisms/ml is taken. The raw milk is treated under conditions similar to those described in Example 1.

FIG. 3 shows an example of the change in the pH of a fermentation medium, formed of a raw milk containing in the region of 1.1 10⁴ microorganisms/ml, of a first stabilising fermentation step of a stabilisation treatment at 27° C. according to the invention. FIG. 3 shows said change in the pH of the fermentation medium of said first stabilising fermentation step at 27° C. when the acidifying lactic fermentation is not interrupted when the pH of said fermentation medium reaches a value in the region of 5.2. The duration of the lag phase, defined as the early part of the kinetics during which the pH value is substantially invariant, is in the region of 15 hours. The pH of the fermentation medium reaches a value of 6.0 after an acidifying lactic fermentation time of 16 hours, a value of 5.2 after 18 hours and a value of 4.9 after 19 hours. The pH of the fermentation medium stabilises at a value in the region of 4.3 in approximately 30 hours. Accordingly, in order to carry out a method according to the invention, the fermentation medium of the first stabilising fermentation step is a raw milk and the acidifying lactic fermentation of the fermentation medium would advantageously be interrupted when the pH of the fermentation medium reaches 5.2, especially after 18 hours.

FIG. 5 shows the change the composition of the revivifiable aerobic mesophilic flora (FMAR) (a), the coliform flora (b), Escherichia coli (c), staphylococci (d), yeasts (e), moulds (f) and the useful flora (g) of the fermentation medium during the successive steps of a stabilisation treatment of a raw milk containing in the region of 1.1 10⁴ microorganisms/ml. The analysis corresponding to series 0 of FIG. 5 (solid bars) represents the count of the starting raw milk. The analyses corresponding to series 1, 2, 3, 4 and 5 of FIG. 5 represent the counts of the fermentation medium at pH 5.2 of the first, second, third, fourth and fifth stabilising fermentation steps, respectively, of the stabilisation treatment.

The numerical values corresponding to those counts are given in Table 2 below. The microbiological composition of the useful flora (g) detailed in Table 2 brings together the totality of the streptococci (h), the lactococci (i), the lactobacilli (j) and the leuconostoc (k). In Table 2, nd means not detectable.

TABLE 2

| | | | | | | | g | | | |
|---|---|---|---|---|---|---|---|---|---|---|
| | a | b | c | d | e | f | h | i | j | k |
| 0 | 1.1E+4 | 2.2E+2 | 2.0E+1 | 3.0E+1 | 2.0E+2 | 4.0E+1 | 4.1E+3 | 1.3E+3 | 4.0E+2 | 1.2E+2 |
| 1 | 2.72E+9 | 3.84E+7 | 3.84E+7 | 1.6E+3 | 2.4E+7 | nd | 2.0E+8 | 2.32E+8 | 8.0E+8 | 9.6E+7 |
| 2 | 6.3E+8 | 8.4E+6 | 8.4E+6 | nd | nd | nd | 4.5E+7 | 3.5E+7 | 1.53E+8 | 3.0E+6 |
| 3 | 8.4E+8 | 1.5E+5 | 1.5E+5 | nd | nd | nd | 1.16E+8 | 1.16E+8 | 2.5E+8 | 1.1E+6 |
| 4 | 1.76E+9 | 2.3E+4 | 2.3E+4 | nd | nd | nd | 1.08E+8 | 1.88E+8 | 1.16E+8 | 7.4E+6 |
| 5 | 1.6E+9 | 2.5E+4 | 2.5E+4 | nd | nd | nd | 4.2E+8 | 1.08E+8 | 1.52E+8 | 1.3E+8 |

nd = not detectable

In the first stabilising fermentation step, the FMAR count (a) changes from an initial value (series 0) in the raw milk of 1.1 10⁴ microorganisms/ml to a final value in the successive fermentation media at pH 5.2 (series 1, 2, 3, 4 and 5) in the region of 1.2 10⁹ microorganisms/ml. The count of useful flora (g) changes from an initial value (series 0) in the raw milk of 5.9 10³ microorganisms/ml to an average final value in the successive fermentation media at pH 5.2 (series 1, 2, 3, 4 and 5) which is stable and in the region of 1.06 10⁹ microorganisms/ml.

Furthermore, the count of coliform flora (c) increases significantly from an initial value (series 0) in the raw milk of 220 microorganisms/ml to a value in the fermentation medium at pH 5.2 (series 1) of the first stabilising fermentation step of 3.84 10⁷ microorganisms/ml, then decreases in the fermentation media of the subsequent successive stabilising fermentation steps (series 2, 3, 4 and 5) to a value in the region of 2.50 10⁴ microorganisms/ml. Accordingly, the proportion of coliform bacteria relative to the FMAR changes from a value in the region of 2% in the raw milk to a value in the region of 0.0015% in the leaven obtained after the fifth stabilising fermentation step, thus reflecting a depletion of coliform flora in the leaven.

It will also be seen that the Escherichia coli bacteria, the proportion of which relative to the FMAR is 1 Escherichia coli bacterium per 550 bacteria of the total flora (FMAR) in the raw milk and 1 Escherichia coli bacterium per 6.4 10⁴ FMAR in the fermentation medium of the fifth stabilising fermentation step, thus reflecting a depletion of Escherichia coli bacteria in the leaven.

It is further observed in FIG. 5 and Table 2 that the staphylococci (d), the yeasts (e) and the moulds (f) disappear completely from the successive fermentation media from the second stabilising fermentation step (series 3) of a stabilisation treatment according to the invention.

Furthermore, the inventors have observed that the acidification kinetics of the fermentation media of the stabilising fermentation steps of a stabilisation treatment according to the invention are similar starting from the second stabilising fermentation step. The kinetics exhibit a lag phase in the region of 150 minutes, reach a pH of 6.0 between 210 minutes and 250 minutes, a pH of 5.2 between 290 minutes and 320 minutes, and stabilise at a pH in the region of pH 4.5 after 400 minutes.

### EXAMPLE 3

### Preparation of a Leaven from a Raw Milk Containing in the Region of 6.5 10³ microorganisms/ml.

1 litre of cow's raw milk having a low FMAR (revivifiable aerobic mesophilic flora) count in the region of 6.5 10³ microorganisms/ml is taken. The raw milk is treated under conditions similar to those described in Example 1.

FIG. 6 shows the change in the composition of the revivifiable aerobic mesophilic flora (FMAR) (a), the coliform flora (b), Escherichia coli (c), staphylococci (d), yeasts (e), moulds (f) and the useful flora (g) of the fermentation medium during the successive steps of a stabilisation treatment of an ultra-clean raw milk containing in the region of 6.5 10³ microorganisms/ml. The analysis corresponding to series 0 of FIG. 6 (solid bars) represents the count of the starting raw milk. The analyses corresponding to series 1, 2, 3, 4, 5 and 6 of FIG. 6 represent the counts of the fermentation medium at pH 5.2 of the first, second, third, fourth, fifth and sixth stabilising fermentation steps, respectively, of the stabilisation treatment.

The numerical values corresponding to those counts are given in Table 3 below. The microbiological composition of the useful flora (g) detailed in Table 3 brings together the totality of the streptococci (h), the lactococci (i), the lactobacilli (j) and the leuconostoc (k). In Table 3, nd means not detectable.

TABLE 3

| | | | | | | | g | | | |
|---|---|---|---|---|---|---|---|---|---|---|
| | a | b | c | d | e | f | h | i | j | k |
| 0 | 6.5E+3 | 6.0E+0 | nd | nd | 5.0E+1 | 2.0E+1 | 2.05E+3 | 7.5E+2 | 2.5E+2 | 1E+1 |
| 1 | 1.55E+9 | 2.46E+4 | nd | nd | 1.4E+5 | 3E+0 | 3.5E+8 | 1.53E+8 | 5.92E+8 | 1.54E+6 |
| 2 | 5.5E+8 | 7.2E+3 | nd | nd | 5.4E+3 | 1E+0 | 2.5E+8 | 7.5E+7 | 9.7E+7 | 5.3E+6 |
| 3 | 6.5E+8 | 1.45E+2 | nd | nd | 5.3E+1 | nd | 1.9E+8 | 2.84E+8 | 7.5E+7 | 4.3E+6 |
| 4 | 1.2E+9 | 4E+0 | nd | nd | nd | nd | 2.2E+8 | 3.4E+8 | 1.4E+8 | 2.1E+6 |
| 5 | 9.95E+8 | nd | nd | nd | nd | nd | 2.7E+8 | 4.5E+8 | 1.2E+8 | 4.7E+6 |
| 6 | 1.1E+9 | nd | nd | nd | nd | nd | 3.5E+8 | 3.2E+8 | 9.8E+7 | 5.5E+6 |

nd = not detectable

In the first stabilising filtration step, the FMAR count (a) changes from an initial value (series 0) in the raw milk of 6.5 10³ microorganisms/ml to a final value in the successive fermentation media at pH 5.2 (series 1, 2, 3, 4, 5 and 6) in the region of 1.0 10⁹ microorganisms/ml. The count of useful flora (g) changes from an initial value (series 0) in the raw milk of 3.06 10³ microorganisms/ml to an average final value in the successive fermentation media at pH 5.2 (series 1, 2, 3, 4, 5 and 6) which is stable and in the region of 8.0 10⁸ microorganisms/ml.

Furthermore, the count of coliform flora (b) increases significantly from an initial value (series 0) in the raw milk of 6 microorganisms/ml to a value in the fermentation medium at pH 5.2 (series 1) of the first stabilising fermentation step of 2.46 10⁴ microorganisms/ml, then decreases in the fermentation media of the subsequent successive stabilising fermentation steps (series 2, 3 and 4) until it disappears in the fermentation media of steps 5 and 6. Accordingly, the proportion of coliform bacteria relative to the FMAR changes from a value in the region of 0.1% in the raw milk to a value of zero in the leaven obtained after the fifth stabilising fermentation step.

It will also be seen that the Escherichia coli bacteria (c) and the staphylococci (d), which are not detectable in the ultra-clean raw milk, are not detectable either in the leaven obtained from that ultra-clean raw milk.

It is further observed in FIG. 6 and Table 3 that the yeasts (e) and the moulds (f) disappear completely from the successive fermentation media in the fourth stabilising fermentation step (series 4) of a stabilisation treatment according to the invention.

1-19. (canceled)

20. Method for preparing a leaven, in which:
a raw milk is chosen from the group consisting of raw milks whose pH, in a step, called the selection step, of stabilising fermentation by acidifying lactic fermentation of the raw milk at least one temperature, called the selection temperature, of from 20° C. to 42° C., is capable of reaching a value of 5.5 in more than 15 hours and a minimum value of 5.0 in less than 48 hours, and then
a raw milk stabilisation treatment is carried out, said treatment comprising at least one step, called the stabilising fermentation step, of acidifying lactic fermentation of a fermentation medium, including a first stabilising fermentation step carried out using a fermentation medium comprising said raw milk, in which at least one stabilising fermentation step of said treatment is interrupted when the pH of the fermentation medium reaches a value of from 4.6 to 6.0, in particular a value in the region of 5.2.

21. Method as claimed in claim 20, wherein the selection temperature is in the region of 27° C.

22. Method as claimed in claim 20, wherein said first stabilising fermentation step is carried out without artificially adding or removing microbiological species to/from the raw milk.

23. Method as claimed in claim 20, wherein each stabilising fermentation step is carried out at a predetermined temperature of from 18° C. to 35° C.

24. Method as claimed in claim 20, wherein the first stabilising fermentation step is interrupted after an acidifying lactic fermentation time of the fermentation medium of from 12 hours to 36 hours.

25. Method as claimed in claim 20, wherein the fermentation medium of the first stabilising fermentation step is a raw milk derived from a mammal, especially a raw milk chosen from the group consisting of raw milk derived from a cow, raw milk derived from a ewe, raw milk derived from a goat and raw milk derived from a buffalo.

26. Method as claimed in claim 20, wherein the fermentation medium of the first stabilising fermentation step contains living microorganisms in a concentration of from 5 10³ to 5 10⁵ living microorganisms/ml.

27. Method as claimed in claim 20, wherein at least two—especially six—successive stabilising fermentation steps are carried out, each stabilising fermentation step being interrupted.

28. Method as claimed in claim 27, wherein each stabilising fermentation step is interrupted by cooling the fermentation medium to a temperature below +4° C.

29. Method as claimed in claim 20, wherein at least one step, called a subsequent stabilising fermentation step, is carried out after the first stabilising fermentation step, using a fermentation medium formed of a quantity of a liquid culture medium and a quantity of a fermentation medium, called the preceding fermentation medium, obtained at the end of a preceding stabilising fermentation step, in a ratio by volume of the quantity of preceding fermentation medium to the quantity of fermentation medium of from 0.5% to 25%, especially from 1% to 5%, in particular in the region of 2%.

30. Method as claimed in 29, wherein the liquid culture medium is a sterilised and osmosed lactose-containing liquor having a solids content of from 4 to 20 wt. %, especially 12 wt. %.

31. Method as claimed in claim 29, wherein the pH of the liquid culture medium is from 6.5 to 7.0.

32. Method as claimed in claim 20, wherein said preceding fermentation medium has a pH value of from 4.6 to 6.0 and contains from 5 10⁷ to 5 10⁹ microorganisms/ml.

33. Method as claimed in claim 20, wherein the raw milk is chosen from the group consisting of raw milks whose pH, in a step, called the selection step, of stabilising fermentation by acidifying lactic fermentation of the raw milk at the selection temperatures of 27° C. and 40° C., is capable of reaching a value of 5.5 in more than 15 hours and a minimum value of 5.0 in less than 48 hours.

34. Leaven derived from raw milk:
containing more than 10⁷ microorganisms/ml, especially from 5.10⁷ to 5 10⁹ microorganisms/ml, and
containing from 5 to 100 different microbiological species and sub-species, especially from 5 to 30 identifiable species and sub-species, in particular from 5 to 12 microbiological species and sub-species, said microbiological species and sub-species being derived from the raw milk solely by spontaneous fermentation thereof,
and in which more than 80% of the microbiological species and sub-species contained in the leaven are derived from the useful flora of the raw milk.

35. Leaven as claimed in claim 34, wherein it is substantially free of coliforms, Escherichia coli and staphylococci.

36. A method of preparing a fermented specialty comprising carrying out fermentation using the leaven according to claim 34.

37. The method as claimed in claim 36, wherein the fermented specialty is a fermented milk product, and the fermentation of a raw milk is carried out.

38. The method as claimed in claim 36, wherein the fermented specialty is a fermented milk product, and the fermentation of a milk selected from the group consisting of raw milks, raw milks that have undergone thermal treatment, raw milks that have undergone athermal treatment, reconstituted milks and standardised milks is carried out.
